(19) United States
(12) Patent Application Publication
(10) Pub. No.: US 2017/0110211 A1
(43) Pub. Date: Apr. 20, 2017

(54) Method to produce a high-purity Zr-89 through physical irradiation and measurement thereof

(71) Applicants: Ming-Hsin LI, Taoyuan (TW); Ting-Shien DUH, Taoyuan (TW); Wuu-Jyh LIN, Taoyuan (TW); Han-Hsiang CHU, Taoyuan (TW)

(72) Inventors: Ming-Hsin LI, Taoyuan (TW); Ting-Shien DUH, Taoyuan (TW); Wuu-Jyh LIN, Taoyuan (TW); Han-Hsiang CHU, Taoyuan (TW)

(21) Appl. No.: 14/882,456

(22) Filed: Oct. 14, 2015

(51) Int. Cl. G21G 1/00; G21G 1/10

(52) U.S. Cl. CPC G21G 1/001; G21G 1/10; G21G 2001/0094

(57) ABSTRACT

A method to produce a high-purity Zr-89 on a solid target through physical irradiation and measurement by selecting a target Barn value of the cross-sectional area of nuclear reaction, drawing a horizontal line to intersect at two points on the function diagram curve and drawing a vertical line downward from each of the two points intersecting at X-axis to obtain incident energy values at the two intersecting points on the X-axis, and followed by plotting an attenuation function diagram curve of penetration depth versus incident energy of Y-89(p,n)Zr-89, selecting an attenuation function diagram curve and a minimum attenuation position of the selected attenuation function diagram curve in correspondence to the incident energy in the interval of incident energy absorption range to obtain an optimal plating thickness value on the solid target.

### BACKGROUND OF THE INVENTION

1. Field of the Invention

The present invention relates to a method for producing a high-purity Zr-89 (zirconium-89) with a physical irradiation and measurement on a solid target, in particular, to a method of producing a high yield primary radionuclide with aid of a physical irradiation and measurement to minimize other irrelevant radionuclide reaction.

2. Description of Related Art

A process usually adopted for producing high-purity zirconium (Zr)-89, such as, plating stable metal Y-89 (yttrium-89) metal ions on a solid target, compacting the oxidation state of Y-89 on a solid target, or packaging Y-89 foil on a solid target, needs to apply various strength of irradiation energy (Mev) for irradiating the solid target by try and error without taking account of the relationship between the strength of the irradiation energy and the metal plating thickness of the Y-89 solid target into consideration, and simply uses radioactivity measurement apparatus to measure their activity and calculate the yield after irradiation.

At the end of irradiating solid targets, when using inorganic acids, such as hydrochloric acid (HCl), to wash off the radioactive radionuclide Y-89 from the target body of the solid target and use radioactivity measuring apparatus to measure the level of activity, while use organic and inorganic adsorbents for directly absorbing the radioactive radionuclide Y-89, there are many impurities from other nuclear species can be found. This takes place while irradiating the solid target with different irradiation energy and producing in parallel other radionuclide reaction other than the major radionuclide in reaction that contains many impurities being generated therewith, because the half-life of the impurities is close to that of the main radionuclide, causing false radioactive dose value, and while washing off Zr-89 metal ion after decay of Y-89 cause the generator interfering pre-treatment efficiency and reducing yield of labeling radiopharmaceutical.

In view of conventional production method of high-purity Zr-89 with drawbacks, the present invention tends to provide an improved method to mitigate and obviate the aforementioned problems.

### SUMMARY OF THE INVENTION

The primary object of the present invention is to provide a method for production of a high-purity Zr-89 on a solid target through physical irradiation and measurements that exploit a function diagram curve of 89Y(p, n)89Zr incident energy versus cross-sectional area of nuclear reaction and a function diagram curve of 89Y(p, n)89Zr solid target thickness versus attenuation of incident energy of nuclear reaction through physical irradiation and measurement techniques. The irradiation energy of radionuclide Y-89 on solid targets can be calculated to generate a set of production parameters for use in the production process, and the production parameters adopted in the process of irradiation of Y-89 can produce stable and uniform quality of Y-89 radionuclide, and the impurity content is predictable and controllable in line with its physical and chemical properties.

To achieve the objective, the present invention provides a method including steps:

Step S11, plotting a function diagram curve of nuclear incident energy versus reaction cross-sectional area for each of Y-89(p, n) Zr-89 and relevant zirconium (Zr)-88, zirconium (Zr)-87, and the kinds in accordance with each of their atomic physical characteristics, and providing an equation for the function diagram curve;

Step S12, selecting a target Barn value of the cross-sectional area of nuclear reaction and drawing a horizontal line to intersect at two points on the function diagram curve of nuclear incident energy versus reaction cross-sectional area, followed by drawing a vertical line downward from each of the two points on the function diagram curve and intersecting at X-axis to obtain incident energy values (E1, E2) at the two intersecting points on the X-axis;

Step S13, substituting the two incident energy values (E1, E2) into the equation of each of the function diagram curve of nuclear incident energy versus reaction cross-sectional area, respectively, obtaining a set of reaction cross-sectional area in correspondence to an interval between the two values (E1, E2) of incident energy;

Step S14, repeating Step S12˜S13 in selecting another target Barn value and obtaining a set of reaction cross-sectional area in correspondence to each function diagram curve;

Step S15, determining if the number of set of reaction cross-sectional area is sufficient, if it is not, repeating Step S14, and if it is affirmative, proceeding to next step;

Step S16, measuring the area size of each set of reaction cross-sectional areas obtained in Step S14, selecting a maximum Zr-89 reaction cross-sectional area Aa-Zr89 while the Zr-88 average reaction cross-sectional area Bb-Zr88 is tolerable or minimum, and obtaining a set of optimal incident energy (Ea, Eb) in correspondence to the two intersecting points of the function diagram curve, calculating an absorption range of the incident energy in correspondence to the interval of incident energy (Ea, Eb), ΔEi(MeV)=Eb(MeV)−Ea(MeV);

Step S17, plotting an attenuation function diagram curve of penetration depth versus incident energy of Y-89(p,n)Zr-89, selecting an attenuation function diagram curve, in correspondence to an optimal incident energy Eb, a minimum attenuation position of the selected attenuation function diagram curve in correspondence to the incident energy Ea, in the interval of incident energy absorption range ΔEi, to obtain an optimal plating thickness value (d), as shown in FIG. 5.

The attenuation function diagram curve is plotted in accordance with its atomic physical characteristic of Y-89(p,n)Zr-89, and selecting a minimum area of Zr-88 in correspondence to the position of an optimal incident energy Eb in the interval of incident energy absorption range ΔEi, as shown in FIG. 4 a shaded area BbZr88, and draw a vertical line from the selected position of the optimal incident energy Eb on the attenuation function diagram curve, as shown in FIG. 5, intersecting on the X-axis to obtain an optimal plating thickness value (d).

Other objects, advantages and novel features of the invention will become more apparent from the following detailed description when taken in conjunction with the accompanying drawings.

### BRIEF DESCRIPTION OF THE DRAWINGS

FIG. 1 is a process flow diagram of the present invention;

FIG. 2 is a function diagram curve of nuclear incident energy versus reaction cross-sectional area of Y-89(p,n)Zr-89 and relevant radionuclide;

FIG. 3 is a function diagram curve of incident energy versus cross-sectional area of nuclear reaction with indication of marked areas in correspondence with incident energy through taking a target Barn value from the Y-axis of cross-sectional area in FIG. 2;

FIG. 4 is a function diagram curve of incident energy versus cross-sectional area of nuclear reaction showing shaded areas in correspondence with incident energy by taking another target Barn value on the Y-axis of cross-sectional area in FIG. 2;

FIG. 5 is an attenuation function diagram curve of penetration depth versus incident energy of Y-89(p,n)Zr-89.

### DETAILED DESCRIPTION OF THE PREFERRED EMBODIMENT

In the preferred embodiments of the present invention, the target Barn value is selected in a range of 0.5 to 1 to minimize the try and error time.

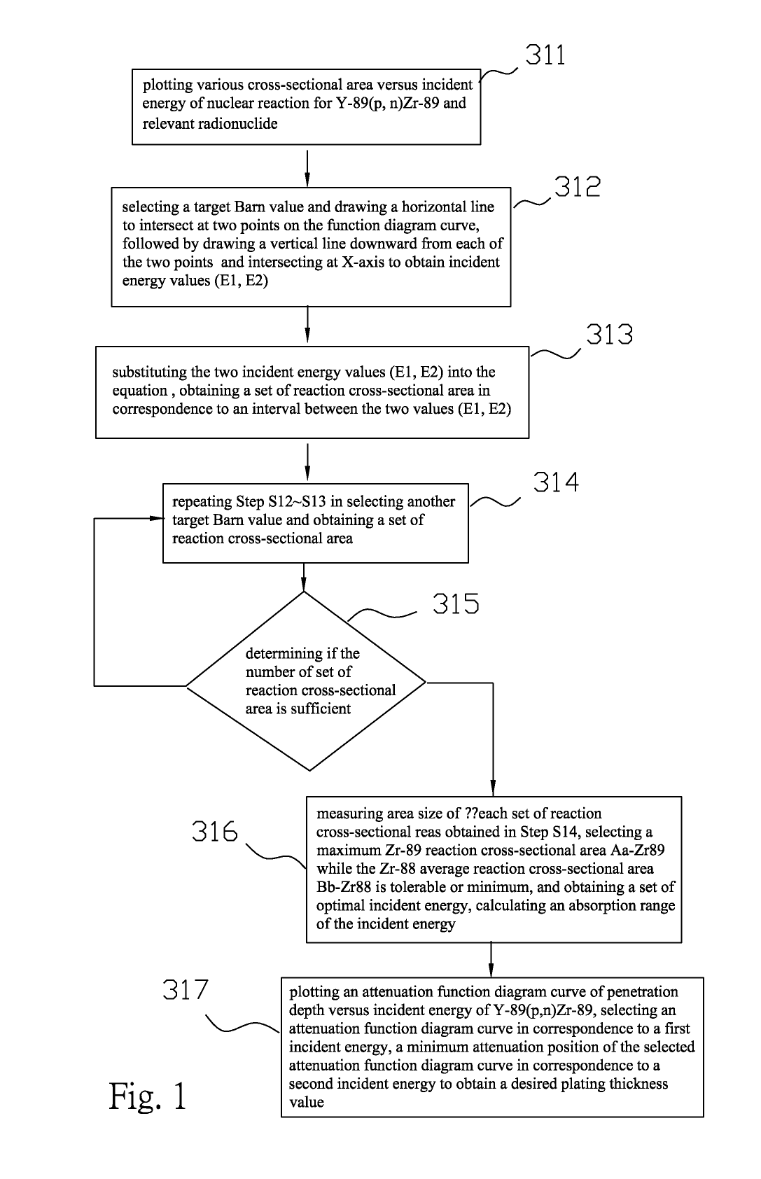

With reference to FIG. 1 through FIG. 5, the method to produce a high-purity Zr-89 on a solid target through physical irradiation and measurement of the present invention comprising in sequence:

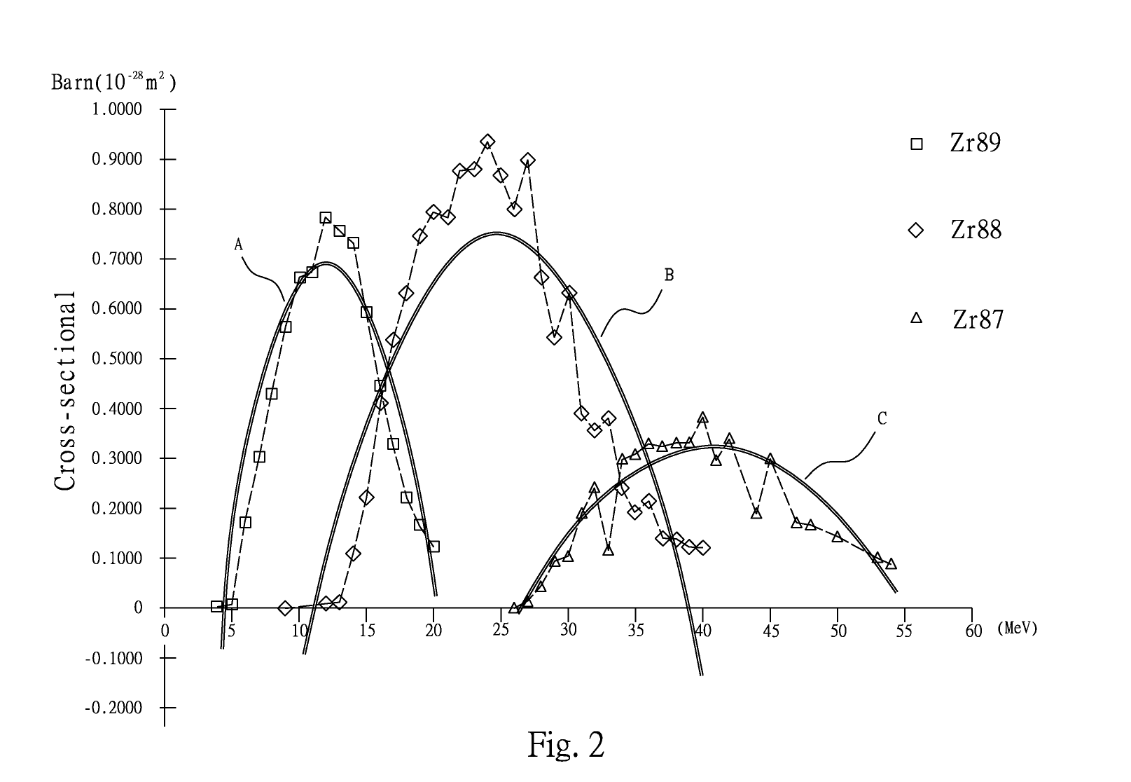

S11 step, In accordance with atomic physical characteristics, plotting various cross-sectional area versus incident energy of nuclear reaction for Y-89(p, n)Zr-89 and relevant Zr-88, Zr-87, as shown in the curves A, B, C (FIG. 2), and formulating the equations of each corresponding function diagram curve:

Curve A: Zr-89ε(4,20)=−0.0115x²+0.2829x−1.0542 (1)

R²=0.9216

Curve B: Zr-88ε(10,40)=−0.0038x²+0.1899x−1.6021 (2)

R²=0.7915

Curve C: Zr-87ε(26,54)=−0.0016x²+0.1275x−2.2649 (3)

R²=0.8192

where R² is a statistical number from 0 to 1 indicating the fitness of the curve that fits the data.

With reference to FIG. 2, the curve B is located in between and intersecting each of curves A and C, and the curves A and C are separately apart.

Step S12, selecting a target Barn value of the cross-sectional area of nuclear reaction and drawing a horizontal line to intersect at two points on the function diagram curve of nuclear incident energy versus reaction cross-sectional area (curve A), followed by drawing a vertical line downward from each of the two points on the function diagram curve and intersecting at X-axis to obtain incident energy values (E1, E2) at the two intersecting points on the X-axis;

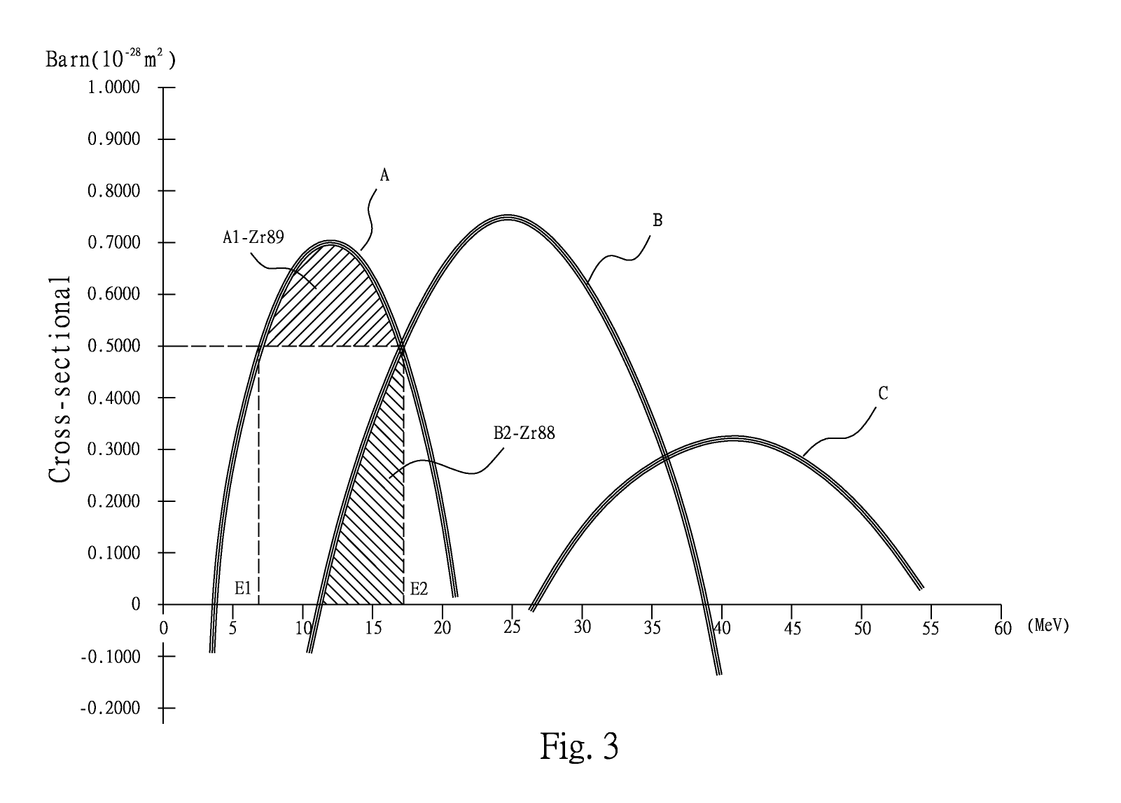

Step S13, substituting the two incident energy values (E1, E2 into the equation (1) and (2) of the function diagram curve of nuclear incident energy versus reaction cross-sectional area, respectively, and integrating in equation (1) and (2) to obtain a set of reaction cross-sectional areas A1-Zr89 and B1-Zr88 in correspondence to an interval between the two values (E1, E2) of incident energy, as shown in FIG. 3, wherein the reaction cross-sectional area A1-Zr89 represents the area contained in the curve A in a interval defined by incident energy (E1, E2), wherein the reaction cross-sectional area B1-Zr88 represents the area contained in the curve B in a interval defined by incident energy (E1, E2), and wherein there is no area contained in the curve C since curve A and C have no intersection in the interval between the two values (E1, E2) of incident energy;

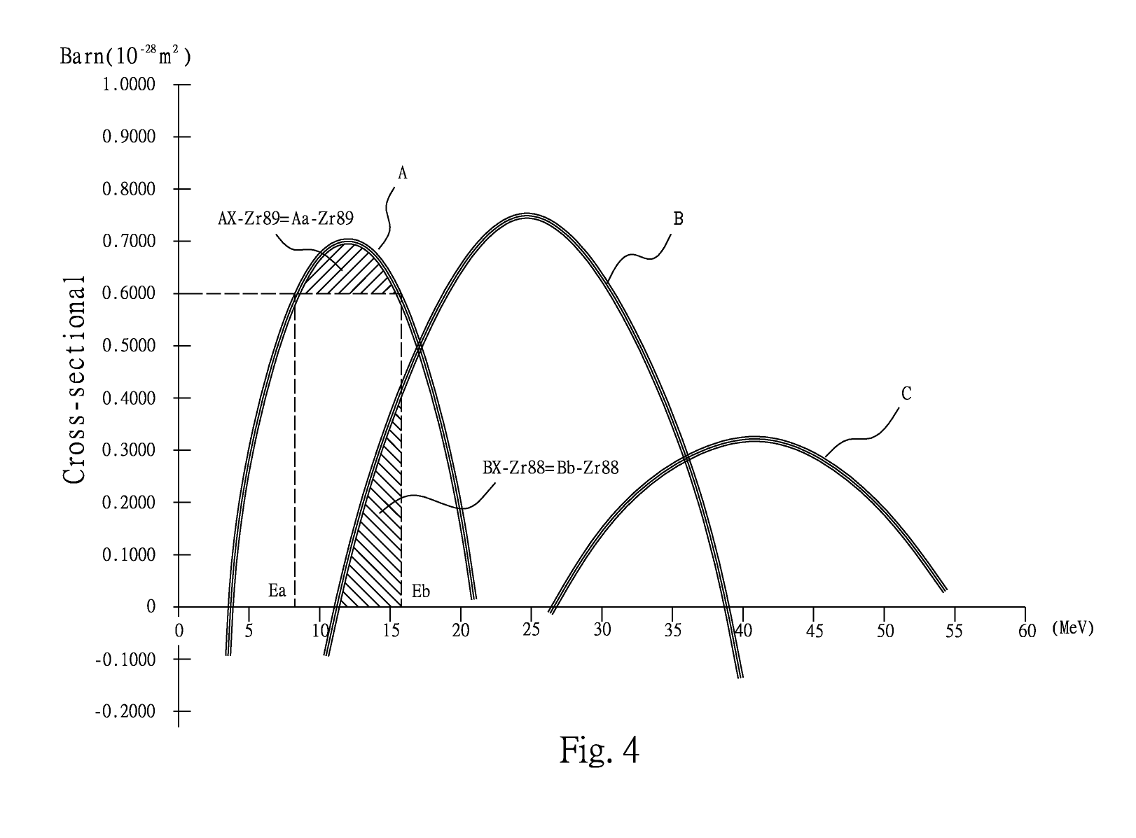

Step S14, repeating Step S12˜S13 in selecting another target Barn value and obtaining a set of reaction cross-sectional areas A1-Zr89 and B1-Zr88 in correspondence to each of function diagram curve A and B, as shown in FIG. 4;

Step S15, determining if the number of set of reaction cross-sectional areas is sufficient, if it is not, repeating Step S14, and if it is affirmative, proceeding to next step;

Step S16, measuring the area size of each set of reaction cross-sectional areas obtained in Step S14, selecting a maximum Zr-89 reaction cross-sectional area Aa-Zr89 while the Zr-88 average reaction cross-sectional area Bb-Zr88 is tolerable or minimum, and obtaining a set of optimal incident energy (Ea, Eb) in correspondence to the two intersecting points on the function diagram curve A, for example, at target Barn value 0.6, as shown in FIG. 4, calculating an absorption range of the incident energy in correspondence to the interval of incident energy (Ea, Eb), ΔEi(MeV)=Eb(MeV)−Ea(MeV);

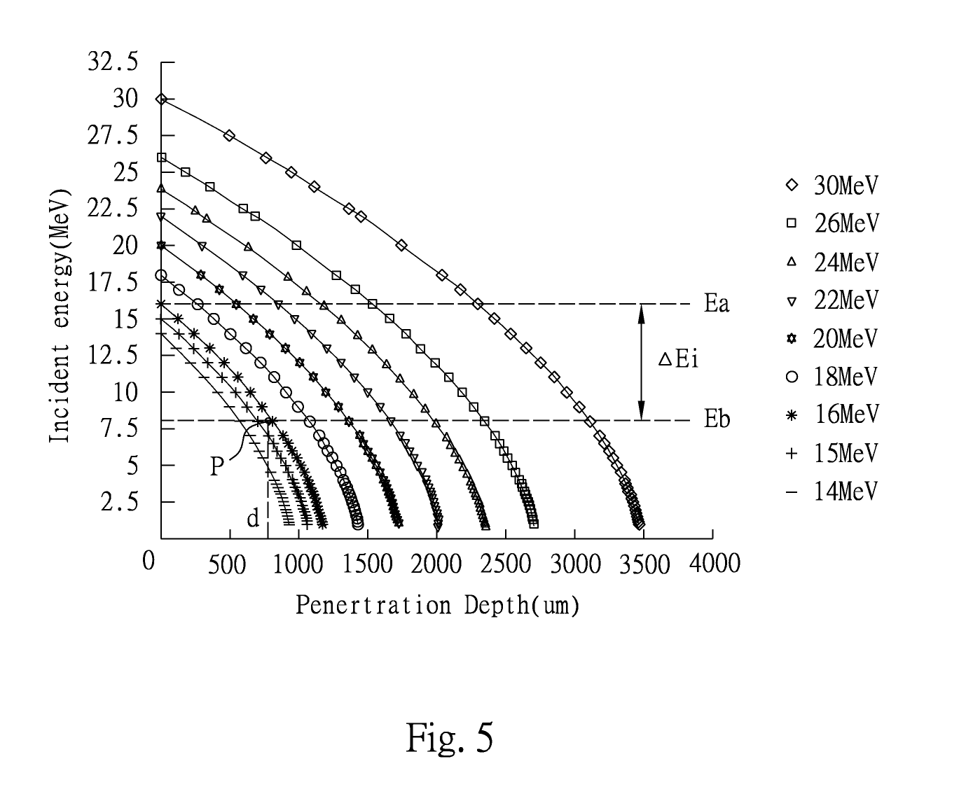

Step S17, plotting an attenuation function diagram curve of penetration depth versus incident energy of Y-89(p,n)Zr-89, selecting an attenuation function diagram curve in correspondence to an optimal incident energy Eb, a minimum attenuation position of the selected attenuation function diagram curve in correspondence to the incident energy Ea, in the interval of incident energy absorption range ΔEi, to obtain an optimal plating thickness value (d) of a solid target, as shown in FIG. 5.

A preferred embodiment of the present invention is described in detail, comprising steps:

Selecting a reaction cross-sectional area target Barn value 0.5, drawing a horizontal line and intersecting at two points on the curve (curve A) of a function diagram of radionuclide Zr-89 incident energy versus reaction cross-sectional area, followed by drawing a vertical line downward from each of the two points on the function diagram curve A and intersecting at X-axis, and obtaining a set of incident energy values (E1, E2) at two intersecting points on the X-axis, as shown in FIG. 3, the incident energy values (E1, E2)=(6.5, 17.5).

Substituting the two incident energy values (E1, E2) into the equation (1) and (2) of the function diagram curves A and B of nuclear incident energy versus reaction cross-sectional area, respectively, and integrating to obtain a reaction cross-sectional area A1-Zr89 and a reaction cross-sectional area B1-Zr88 in correspondence to an interval between the two values (E1, E2) of the incident energy, as shown in FIG. 3.

Selecting another target Barn value 0.6 and repeating the steps described above to obtain a second set of reaction cross-sectional areas A1-Zr89 and B1-Zr88 in correspondence to each of function diagram curve A and B, as shown in FIG. 4;

Determining if the number of sets of reaction cross-sectional areas obtained above is sufficient for comparison, if it is not, repeating described above, and if it is affirmative, proceeding to next step;

Measuring the area size of each set of reaction cross-sectional areas obtained above, and selecting a maximum Zr-89 reaction cross-sectional area Aa-Zr89 while a Zr-88 average reaction cross-sectional area Bb-Zr88 is tolerable or minimum, and obtaining a set of optimal incident energy (Ea, Eb) in correspondence to the two intersecting points on the function diagram curve A, in this case, at target Barn value 0.6, as shown in FIG. 4, calculating an absorption range of the incident energy in correspondence to the interval of incident energy (Ea, Eb)=(8,16), ΔEi(MeV)=Eb(MeV)−Ea(MeV), therefore, the absorption range of the incident energy is ΔEi=Eb−Ea=16−8=8(MeV).

Selecting an attenuation function diagram curve in correspondence to an optimal incident energy Eb=16 (MeV), and in accordance with the absorption range of the incident energy ΔEi=8 (MeV), drawing a horizontal line from Ea=8 (MeV) to intersect at P point of the attenuation curve of the optimal incident energy Eb=16 (MeV), and drawing a vertical line to intersect at X-axis to obtain an optimal plating thickness value d=700 mm of a solid target, as shown in FIG. 5. An interpolation method may be applied for calculating any other optimal plating thickness value (d) of the solid target with other values than what is exemplified thereof.

As a result of the physical measurement and measurement described above, a most desirable irradiation energy parameter is 16 MeV, and the best plating thickness of 700 mm of the solid target is obtained in the preferred embodiment of the present invention. Actual irradiation parameters of accelerator can be adjusted as desired, and an example of the actual irradiation parameters are as follows:

a. irradiation energy: 16 MeV

b. accelerated particle: protons (cyclotron accelerator with fixed irradiation conditions)

c beam current: 200 μA (cyclotron accelerator with fixed irradiation conditions)

d irradiation time: 60 hr (cyclotron accelerator with fixed irradiation conditions)

e irradiation angle: 7 degree (cyclotron irradiation of fixed conditions)

With adoption of cyclotron irradiation, it produces the best yield with minimum other radionuclide undesired.

The physical irradiation and measurement of the present invention is to use these parameters to calculate each irradiation energy parameter in the process of production of the radionuclide yttrium-89 (Y-89) solid target, and the irradiated radionuclide Y-89 quality of the production is maintained uniform, and the impurity content can be predictable and controlled in compliance with their physical and chemical properties.

The method of physical irradiation and measurement of the present invention is to produce a high purity Zr-89, enhancing the probability of producing major nuclide species, while trying to avoid the effect of other minor nuclide species reaction. It is to be understood that even though numerous characteristics and advantages of the present invention have been set forth in the foregoing description, the disclosure is illustrative only, and changes may be made in detail, especially in matters of arrangement of parts within the principles of the invention to the full extent indicated by the broad general meaning of the terms in which the appended claims are expressed.

What is claimed is:

1. A method of physical irradiation and measurement for producing a high purity Zr-89 on a solid target, comprising steps:
Step S11, plotting a function diagram curve of nuclear incident energy versus reaction cross-sectional area for each of Y-89(p, n) Zr-89 and relevant radionuclide zirconium (Zr)-88, zirconium (Zr)-87, and the kinds in accordance with each of their atomic physical characteristics, and providing an equation for the function diagram curve;
Step S12, selecting a target Barn value of the cross-sectional area of nuclear reaction and drawing a horizontal line to intersect at two points on the function diagram curve of nuclear incident energy versus reaction cross-sectional area, followed by drawing a vertical line downward from each of the two points on the function diagram curve and intersecting at X-axis to obtain incident energy values (E1, E2) at the two intersecting points on the X-axis;
Step S13, substituting the two incident energy values (E1, E2) into the equation of each of the function diagram curve of nuclear incident energy versus reaction cross-sectional area, respectively, obtaining a set of reaction cross-sectional area in correspondence to an interval between the two values (E1, E2) of incident energy;
Step S14, repeating Step S12˜S13 in selecting another target Barn value and obtaining a set of reaction cross-sectional area in correspondence to each function diagram curve;
Step S15, determining if the number of set of reaction cross-sectional area is sufficient, if it is not, repeating Step S14, and if it is affirmative, proceeding to next step;
Step S16, measuring area size of each set of reaction cross-sectional areas obtained in Step S14, selecting a maximum Zr-89 reaction cross-sectional area Aa-Zr89 while the Zr-88 average reaction cross-sectional area Bb-Zr88 is tolerable or minimum, and obtaining a set of optimal incident energy in correspondence to the two intersecting points of the function diagram curve, calculating an absorption range of the incident energy in correspondence to the interval of incident energy;
Step S17, plotting an attenuation function diagram curve of penetration depth versus incident energy of Y-89(p,n)Zr-89, selecting an attenuation function diagram curve in correspondence to a first incident energy, a minimum attenuation position of the selected attenuation function diagram curve in correspondence to a second incident energy, in the interval of incident energy absorption range, to obtain a desired plating thickness value.

2. The method of physical irradiation and measurement for producing a high purity Zr-89 on a solid target of claim 1, wherein the target Barn value is selected in a range of 0.5 to 1.
